(19) United States
(12) Patent Application Publication
(10) Pub. No.: US 2009/0118997 A1
(43) Pub. Date: May 7, 2009

(54) Integrated flight data interface for airport traffic control towers

(75) Inventor: Todd Richard Truitt, Egg Harbor Township, NJ (US)

Correspondence Address: Martin E. Robinson, Jr.;Federal Aviation Administration, AGC-500, 800 Independence Ave. SW, Washington, DC, 20591, US

(73) Assignee: Government of the United States, Washington, DC (US)

(21) Appl. No.: 11/979,391

(22) Filed: Nov. 2, 2007

(51) Int. Cl. G06F 19/00; G08G 5/00

(52) U.S. Cl. 701/120

(57) ABSTRACT

A method of displaying electronic flight data together with airport surface detection data in an airport traffic control tower system. The Integrated Electronic Flight Data Interface incorporates Electronic Flight Data with a surface surveillance system.

### STATEMENT OF GOVERNMENT INTEREST

The present invention may be made or used by or for the Government of the United States|without the payment of any royalties thereon.|

### FIELD OF THE INVENTION

The disclosed invention is directed generally to airport traffic control systems, and more particularly to an interactive airport traffic control tower graphical user interface.

### BACKGROUND OF THE INVENTION

Projected increases in air traffic along with modernization efforts have led the Federal Aviation Administration (FAA) to consider replacing paper Flight Progress Strips (FPSs) with an electronic alternative. Electronic Flight Data (EFD) alternatives have the potential to increase a controller's ability to acquire, track, and record information as well as communicate and coordinate that information with others. Paper FPSs have been used by certified air traffic controllers (hereinafter referred to simply as controllers) since the 1930s and 1940s. The FPS has become a historical artifact that limits the usefulness of flight data and consumes valuable cognitive resources.

In today's Airport Traffic Control Tower (ATCT) environment, controllers must manually update information, record clearances, and physically pass FPSs from one controller to another. Controllers must also mentally correlate the flight data information on the FPSs with the aircraft on the airport surface. As the aircraft move across the airport surface, the controller must continually update his/her mental picture of the traffic situation and the associated flight data. All of these activities require cognitive and sensory resources that may be relieved by automation or other less subtle changes in standard operating procedures. The inherent physical limitations of FPSs restrict the controllers' ability to communicate flight data information with other facilities such as the Terminal Radar Approach Control (TRACON), Air Route Traffic Control Center (ARTCC), and Airline Operations Center (AOC). Currently, controllers must perform most communication and coordination between the ATCT and other facilities via a telephone landline.

In some instances, controllers can pass FPSs from the ATCT to the TRACON with a gravity-fed drop tube. However, with the modernization of FAA facilities and the advent of the Electronic Flight Strip Transfer System (EFSTS), drop tubes are becoming outdated. Bar code scanners located at the controllers' workstation and bar codes printed on each FPS enables the EFSTS. Although the EFSTS allows the electronic transfer of information between remote facilities, the EFSTS has number of limitations. The EFSTS requires the FAA to print duplicate FPSs in multiple locations, for example between the ATCT and the TRACON. Changing or updating FPS information that controllers must pass between the ATCT and TRACON is also difficult or impossible with the EFSTS.

ATCT controllers must also be able to handle a dynamic mental representation of multiple aircraft and their respective positions within the airport operations area. Controllers must work to mentally connect each aircraft to the appropriate information on the FPSs such as identification, aircraft type, expected departure time, and runway assignment. The controllers must exert constant mental effort to update this mental picture and maintain the proper connections between the paper FPSs and the associated aircraft. The failure do so may result in the controller forgetting where an aircraft is located and issuing improper instructions that may result in a runway incursion or collision.

In order to maintain their mental picture of the situation, controllers must often search for a FPS and then record hand-written information on it. The search process can be time consuming and requires the controllers to filter out irrelevant information. Controllers must also exert cognitive effort to remember timing information such as when they must space departure aircraft from wake turbulence. Any hand-written information is not stored in the National Airspace System (NAS) computers, and is inaccessible to decision support tools and other air traffic facilities. Furthermore, each ATCT facility has its own FPS marking guide resulting in a lack of standard procedures. While many towers use unique FPS markings to handle unique situations, hand-written information can be unclear and difficult to read.

### BRIEF DESCRIPTION OF THE DRAWINGS

FIG. 1 shows the hardware used to implement the Integrated Electronic Flight Data Interface (EFDI).

FIG. 2 illustrates the primary elements of the ground controller's Integrated EFDI.

FIG. 3 illustrates the primary elements of the local controller's Integrated EFDI.

FIG. 4 shows FDEs in an EFD list and the data blocks for the associated aircraft.

FIG. 5 shows FDEs in the pending list on the ground controller's Integrated EFDI.

FIG. 6 shows FDEs in the outbound list on the ground controller's Integrated EFDI.

FIG. 7 shows FDEs in the departure list on the local controller's Integrated EFDI.

FIG. 8 shows FDEs in the arrival list on the local controller's Integrated EFDI.

FIG. 9 shows FDEs in the inbound list on the local control Integrated EFDI.

FIG. 10 shows a data block for a departing aircraft on the local control Integrated EFDI.

FIG. 11 shows a data block for an arriving aircraft on the local control Integrated EFDI.

FIG. 12 shows the readout area and information for an arriving aircraft.

FIG. 13 shows the readout area and information for a departing aircraft.

FIG. 14 shows a FDE indicating a change to the assigned altitude and/or heading.

FIG. 15 shows amended altitude and heading assignments as depicted in the readout area.

FIG. 16 shows buttons on the Integrated EFDI situation display for runway and intersection departure assignments.

FIG. 17 shows the system information window.

FIG. 18 shows FDEs with ATIS update indicator and the associated indicator near the system information window.

FIG. 19 shows the Integrated EFDI Timer interface.

FIG. 20 shows the generic timer information located to the right of the system information window.

FIG. 21 shows a FDE for an aircraft that has an associated timer indicated by the icon on the right side.

FIG. 22 shows a highlighted FDE.

FIG. 23 shows an aircraft that has taxied into position and is holding on the runway causing highlighting of the aircraft's FDE and data block.

FIG. 24 shows a FDE with a highlighted time field to indicate that an aircraft has an EDCT.

### SUMMARY OF THE INVENTION

The present invention integrates EFD with a surface surveillance system. The surface surveillance system electronically displays aircraft and other vehicles' location on and just above the airport surface. Integrating EFD with a surface surveillance display places flight data information closer to aircraft positions. Instead of controllers examining FPSs for flight data; shifting their visual attention to the surface surveillance display and out-the window to verify aircraft position, and then mentally correlating the disparate sources of information. The integration of EFD and aircraft position allows the controller to build a mental representation from a single source. Associating EFD and aircraft position should also improve controller efficiency by reducing their need to shift visual attention among disparate information sources.

### DETAILED DESCRIPTION OF THE EMBODIMENTS

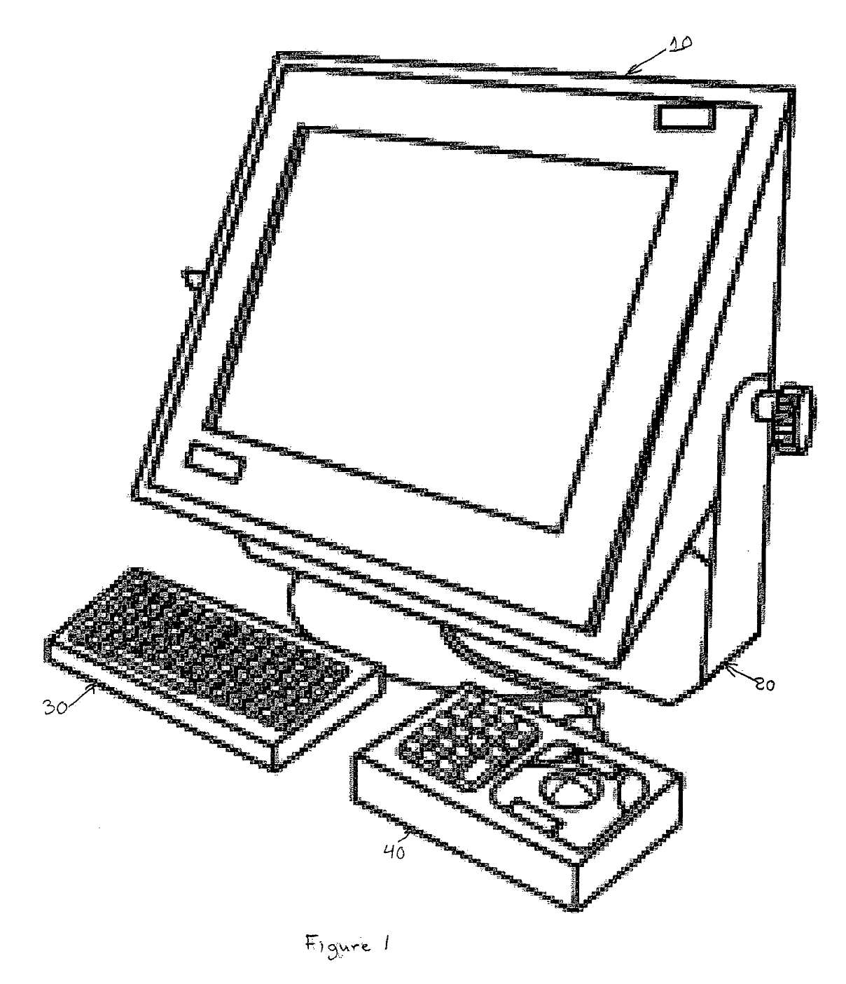

Referring to FIG. 1, the hardware used to implement the Integrated EFDI includes a resistive touch display 10, display mount 20, keyboard 30, and a trackball/keypad combination 40. In the preferred embodiment, the display is a VarTech Systems, Inc. touch sensitive display. This VarTech Systems, Inc. touch sensitive display is a 21.3-inch display that provides an active display area that is 17-inches (432 mm) wide and 12.75-inches (324 mm) high which provide a 1600×1200 pixel format with a viewing angle of 85 degrees. This display uses resistive technology to enable a touch screen that can be activated by either a stylus or by a person's fingertip. This display is mounted on a display mount 20 that supports the weight of the display and allows the user to adjust the horizontal and vertical viewing angle. In the preferred embodiment an actual Airport Surface Detection Equipment-Model X (ASDE-X) keyboard and ASDE-X trackball/keypad combination were used for the keyboard 30 and the trackball/keypad combination 40.

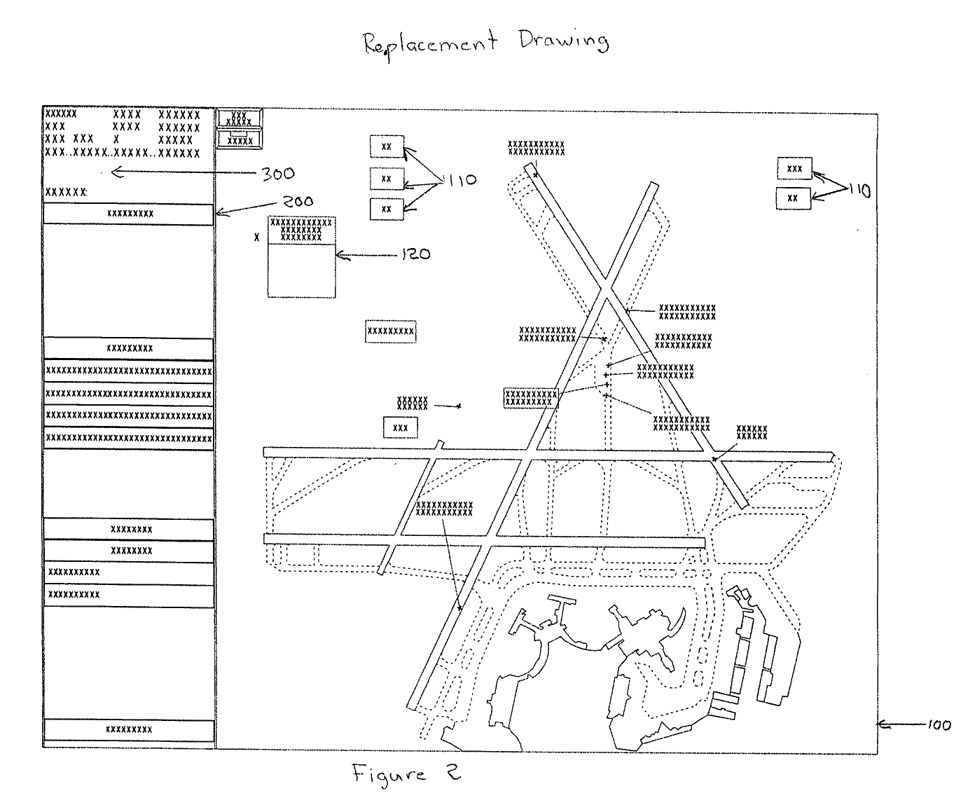

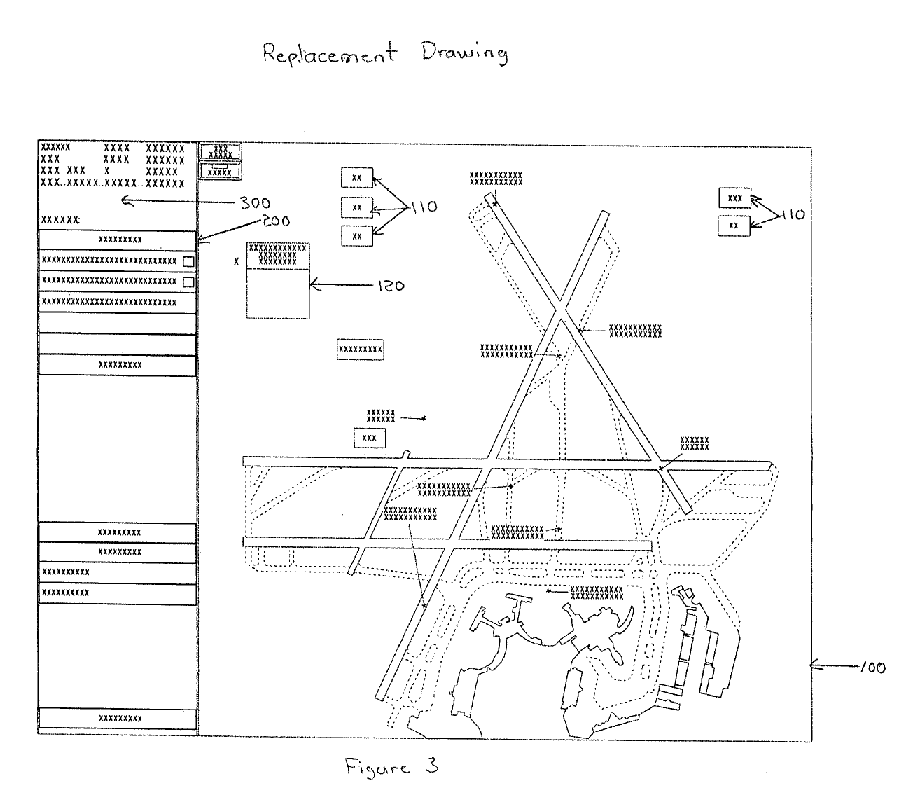

The Integrated EFDI is comprised of two separate interfaces; one for the ground controller and one for the local controller. The ground EFDI and the local EFDI share many task objects. The primary difference between the ground EFDI and the local EFDI is the types of lists that appear on the display. The shared task objects translate into shared graphic user interface (GUI) objects. Referring to FIGS. 2 and 3, the main shared objects are the surface situation display 100, EFD lists 200, and readout area 300.

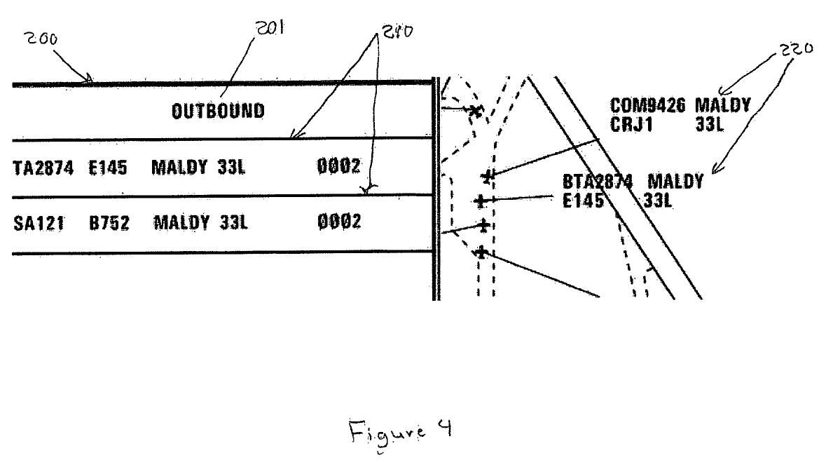

Referring to FIG. 4, the EFD lists 200 are similar to FPS bays in that they contain individual flight data elements (FDEs) 210 that are stacked and sorted. Each FDE 210 contains only the most important and relevant information. The controller can locate the EFD lists 200 on either the left or right side of the surface situation display. Each list has a header 201 that identifies the contents of the list. The list headers 201 are also touch sensitive buttons that allow the controller to move FDEs 210 between lists, controller positions, and other facilities such as a TRACON or AOC. To move an FDE 210 to another list or to transfer it to another position or facility, the controller selects the FDE or associated datablock to transfer and then selects the appropriate list header 201. The list headers 201 provide visual feedback to the controller to indicate activation. Whenever a FDE appears in a list or the controller moves a FDE to a list using a header or button, the FDE appears at the top of the new list. The controller can also resequence FDEs in a list by selecting and dragging a FDE. When dragging a FDE, it remains in its original location and only a frame of the FDE moves across the display. The controller uses the top of the frame as a reference to determine FDE placement. To place a FDE above another FDE, the top of the frame must move above the top of the other FDE. To place a FDE below another FDE, the top of the frame must move below the top of the other FDE. Once the controller moves the frame to the desired location and releases the frame by removing his fingertip from the interface, the FDE will move to the new location. In the preferred embodiment, the FDE movement is animated so that when a controller moves a FDE within a list or inserts a FDE in a new list, there is a visual indication of what happened. For example, when the controller moves a FDE, the FDE will occupy its new position, and the FDEs below it will move out of the way simultaneously. All flight data for an aircraft are associated such that selecting either a FDE 210 or data block 220 will cause all other related fight data displayed to be highlighted. For example, selecting a FDE 210 will highlight the FDE and the associated data block 220. Likewise, selecting a data block 220 will highlight the associated FDE 210.

The preferred embodiment uses a noun-verb command style throughout the EFDIs as opposed to a verb-noun command style. Using the noun-verb command style, the controller first selects an object to act upon (noun) and then selects an action to perform (verb). Using the noun-verb command style reduces errors and increases speed. The noun-verb command style reduces errors because commands take effect when the controller issues them and the controller is focusing attention on the command. In contrast, the verb-noun command style makes the controller chose a command and executes that command as soon as the controller makes a noun selection. Any interruption between the controller's selection of a command and selection of what to act upon may redirect the controller's attention and cause the controller to forget the already selected command, and that the system is waiting for the controller to select an object. Likewise, the controller may select the correct command, but inadvertently select the wrong object. Thus, the verb-noun style creates the potential of applying the command to an unintended object. The preferred noun-verb style increases speed by minimizing the number of times the controller must refocus attention. The noun-verb style allows the controller to select the object to act upon and then redirect attention to select the proper command; a single shift in the focus of attention. In contrast, the verb-noun style requires the controller to select an object to act upon, redirect attention to the proper command, and then redirect attention back to the object to act upon; two shifts in the focus of attention. The verb-noun style also requires a feature that allows the controller to cancel a command. Once the controller selects a command in the verb-noun style and the controller decides not to use that command, then the controller must inform the system by canceling the selected command. With the noun-verb style, if the controller selects the wrong object, the controller just makes another selection of the correct object.

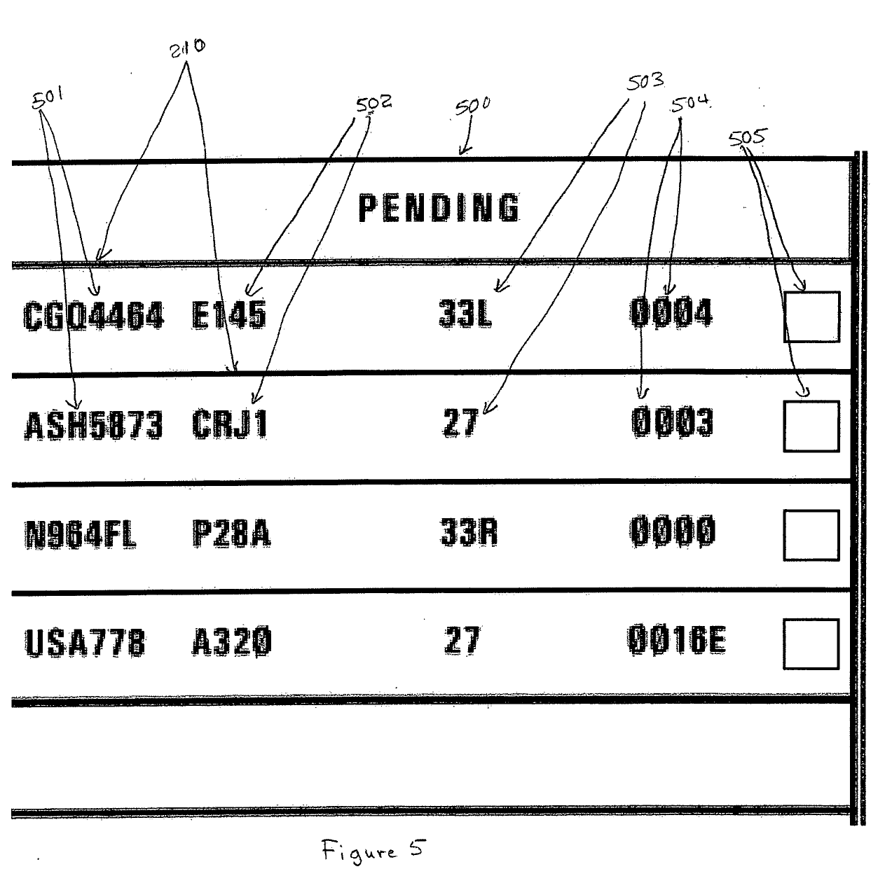

Referring to FIG. 5, the pending list 500 appears on the ground controller's EFDI. The pending list contains FDEs 210 for aircraft that have pushed back from the terminal gate and are waiting on the ramp to contact ground control or to receive taxi instructions. The flight data attributes that appear on each FDE 210 in the pending list are the aircraft call sign 501, aircraft type 502, runway assignment 503, proposed departure time or the Estimated Departure Clearance Time (EDCT) in hours and minutes in Universal Coordinated Time (UCT) 504, and the ATIS update indicator 505. The FDEs 210 appear muted to indicate that these aircraft have not yet contacted the ground controller. When an aircraft makes initial contact with the ground controller, the ground controller verifies that the pilot has the current ATIS code and selects the ATIS update indicator 505 on the right side of the aircraft's FDE 210. When the ground controller issues a taxi clearance, the ground controller moves the FDE into an outbound list by selecting the aircraft's FDE 210 or data block 220 (See FIG. 4) and then selecting the outbound list header.

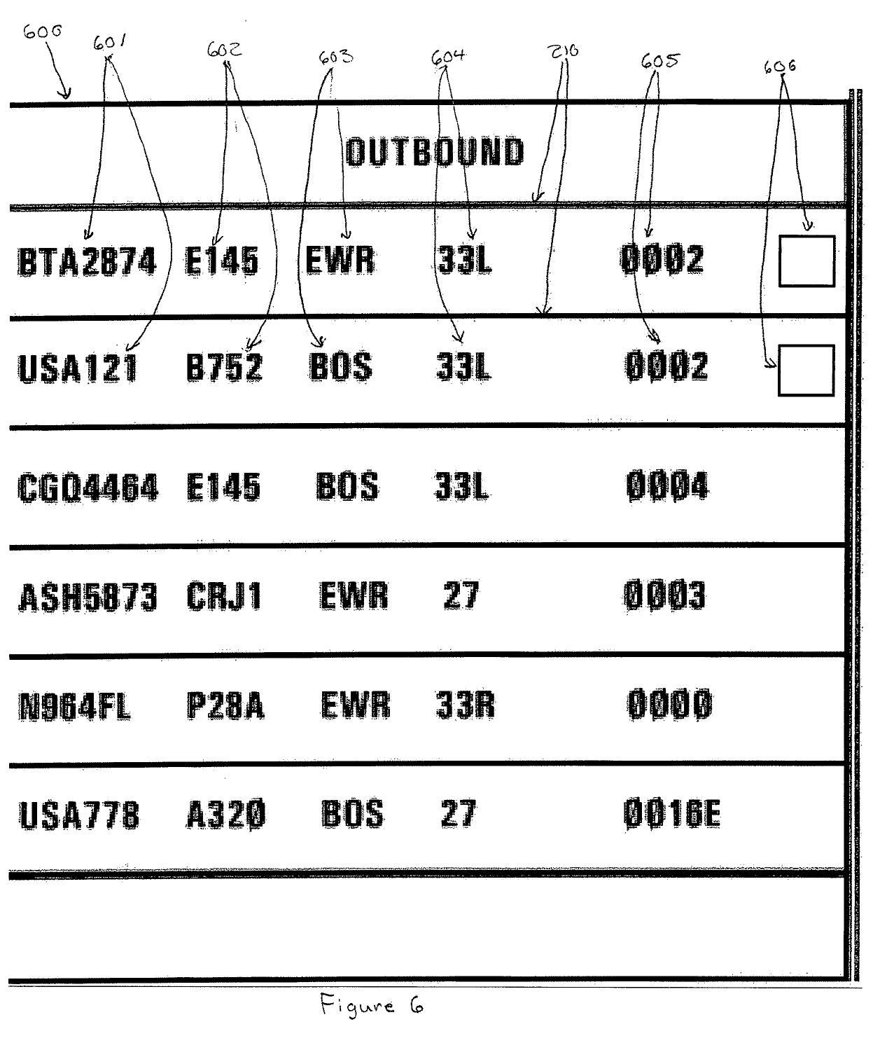

Referring to FIG. 6, the outbound list 600 appears on the ground controller's EFDI. FDEs 210 appear in their active color, for example white, at the top of the outbound list when the ground controller moves them from the pending list. An aircraft FDE appearing in the outbound list indicates that the ground controller has issued a taxi clearance, and the aircraft is taxing from the ramp to the departure runway. When the ground controller places a FDE in the outbound list, the flight data system automatically records a taxi time indicated in hours and minutes UTC, and the taxi time replaces the proposed departure time in the FDE. The flight data attributes that appear in the outbound list 600 are the aircraft call sign 601, aircraft type 602, first departure fix 603, runway assignment 604, taxi time or EDCT 605, and the ATIS update indicator 606. If a FDE 210 contains an EDCT 605, placing the FDE in the outbound list will also automatically record a taxi time, but the EDCT will remain visible. When the ground controller is ready to transfer responsibility of an aircraft, the controller selects the aircraft's FDE or data block from the outbound list and then selects the local header to transfer the aircraft to the local controller.

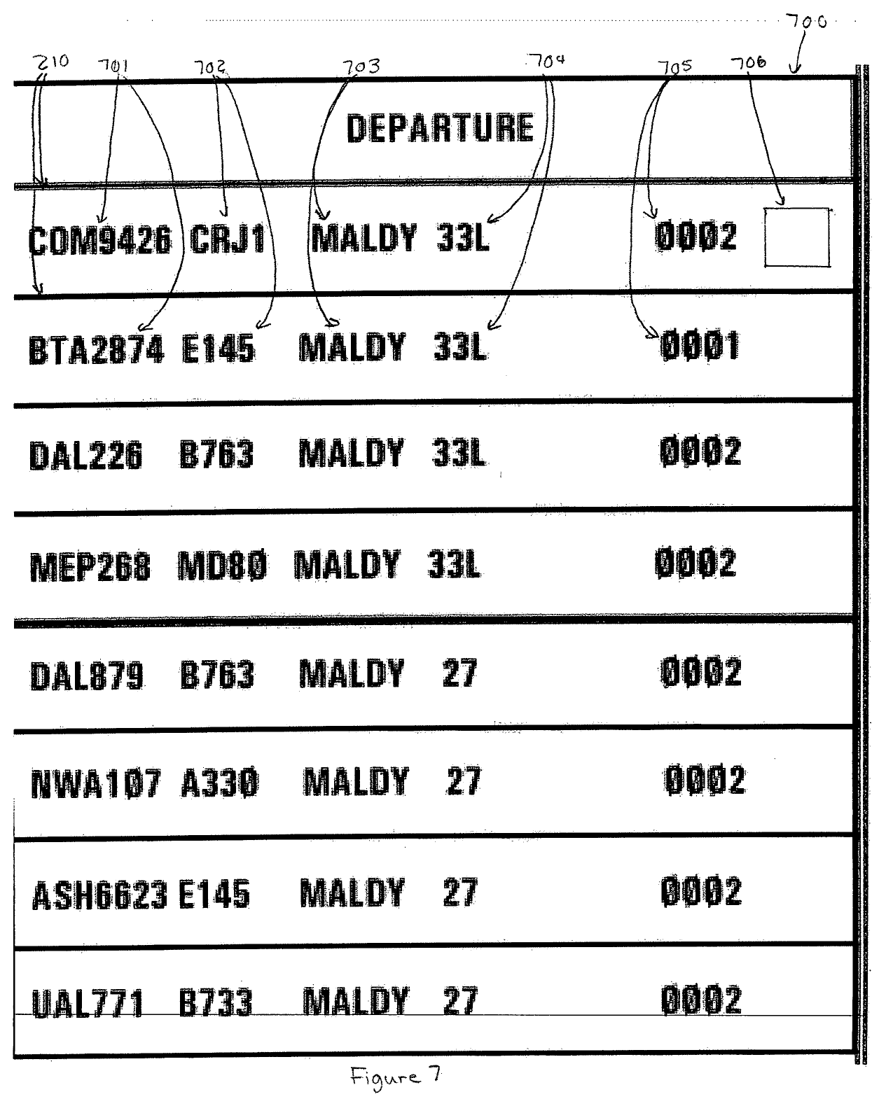

Referring to FIG. 7, when the ground controller transfers a FDE 210 to the local controller, it appears at the top of the departure list 700 on the local controller's EFDI. The flight data attributes that appear on the departure list 700 are the aircraft call sign 701, aircraft type 702, first departure fix 703, runway assignment 704, taxi clearance time or EDCT 705, and the ATIS update indicator 706. If necessary, the local controller can adjust the departure sequence by dragging a FDE 210 to a new position within the departure list 700. Once an aircraft begins its takeoff roll, the flight data system automatically replaces the time field 705 with a timer that begins to increment displayed in minutes and seconds. The local controller can use this timer for departure spacing. Once the local controller has instructed the aircraft to contact the departure controller, the local controller then selects the appropriate FDE 210 or data block followed by the TRACON button to transfer the FDE to the departure controller.

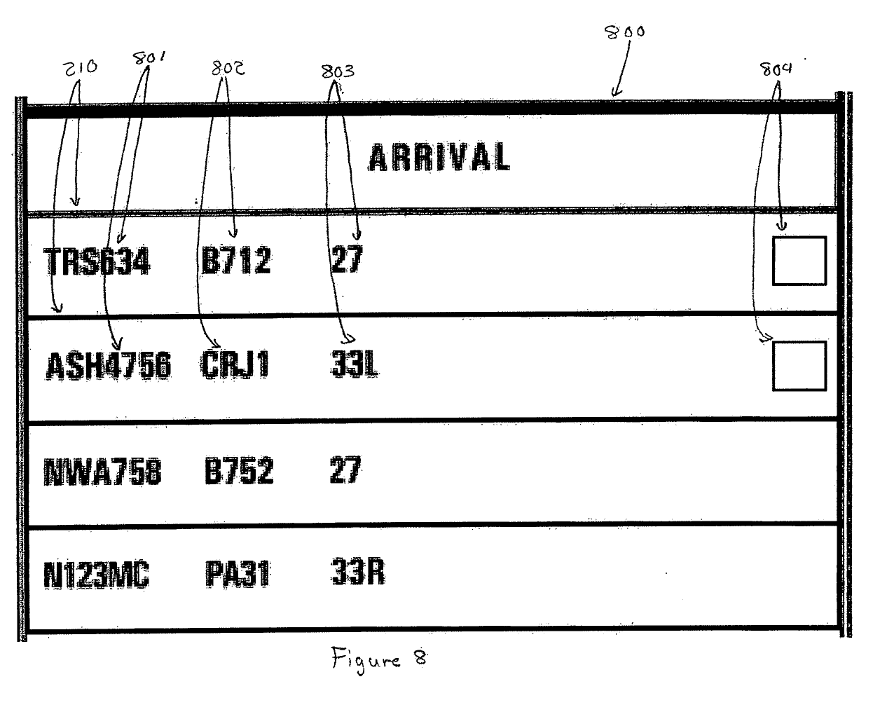

Referring to FIG. 8, the arrival list 800 is located on the local controller's EFDI and shows aircraft that are on approach to the airport. The arrival list FDEs appear in order of the predicted time of arrival at each runway. An aircraft's FDE 210 appears at the top of the arrival list 800 when the aircraft reaches the outer marker or is about 5 nautical miles (nm) from the airport. The flight data attributes contained in the arrival list 800 are the aircraft call sign 801, aircraft type 802, runway assignment 803, and the ATIS update indicator 804. The local controller can change the landing runway assignment for an aircraft by selecting the aircraft's FDE 210 or data block, followed by the appropriate runway button. If necessary, the local controller can adjust the indicated arrival sequence by dragging a FDE 210 to a new position within the arrival list 800. Once an aircraft has landed, and the local controller instructs the pilot to contact ground control, the local controller transfers the FDE 210 to the ground controller by selecting the aircraft's FDE 210 or data block followed by the ground button.

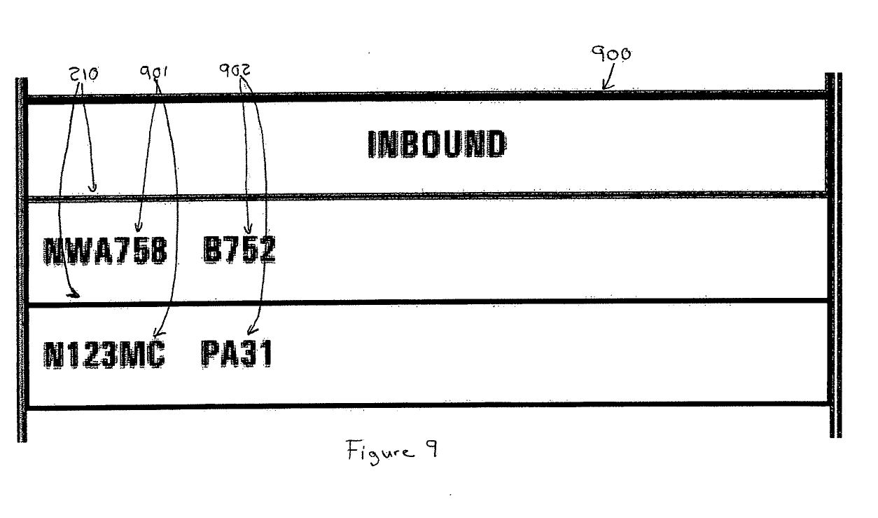

Referring to FIG. 9, when the local controller transfers a FDE 210 to the ground controller, the FDE 210 appears at the top of the inbound list 900 on the ground controller's EFDI. The flight data attributes contained in the inbound list 900 are the aircraft call sign 901 and aircraft type 902. The ground controller will provide the aircraft with a taxi clearance back to the ramp area and then select the aircraft's FDE 210 or data block followed by the ramp button. This sequence of actions causes the aircraft's flight data to appear muted to indicate that the aircraft is leaving the airport surface. The aircraft's data block and FDE will automatically disappear once the aircraft reaches the ramp. An aircraft's data block and FDE will not disappear if the ground controller does not transfer the FDE to the ramp position. This ensures that the ground controller does not forget to transfer communications along with the flight data.

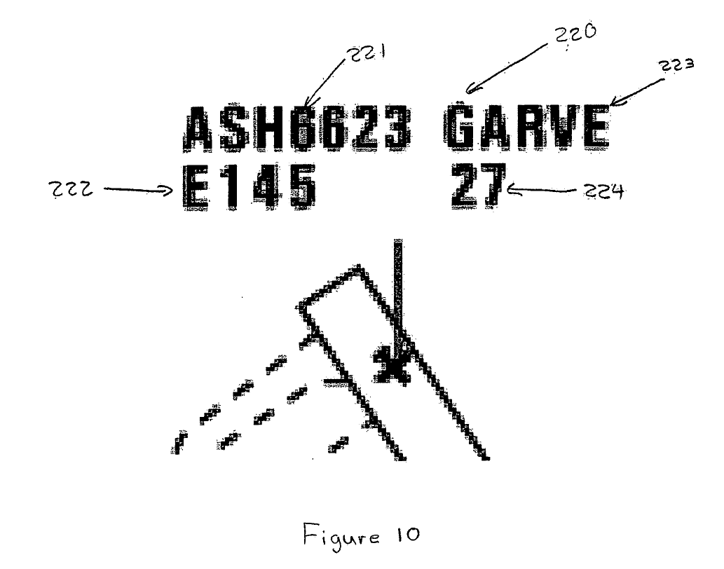

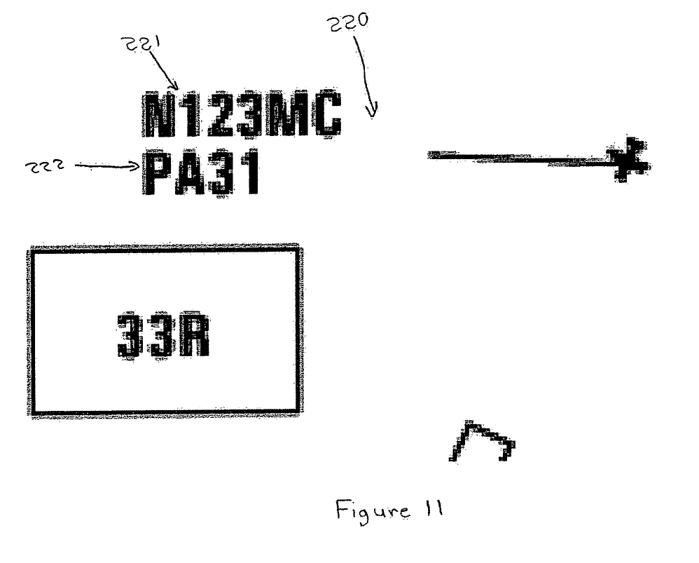

As shown in FIG. 4, the data block format 220 to display only the most important and relevant information for the controller. FIG. 10 shows an example data block 220 for a departing aircraft. The departure data block 220 contains four flight data attributes including the aircraft call sign 221, aircraft type 222, first departure fix 223, and the runway assignment 224. The arrival data block 220 as shown FIG. 11 contains only two flight data attributes; the aircraft call sign 221 and aircraft type 222. These formats are used for the departure and arrival aircraft data blocks on both the ground and local controller's Integrated EFDIs. Like the FDEs, the controllers can select data blocks by touch to perform flight data functions.

As shown in FIGS. 2 and 3, the readout area 300 is located above the EFD lists 200 on the surface situation display 100. Three different types of information may appear in the readout area; full flight data for an arriving aircraft, full flight data for a departing aircraft, or a list of the most recent FDEs transferred to another controller or facility.

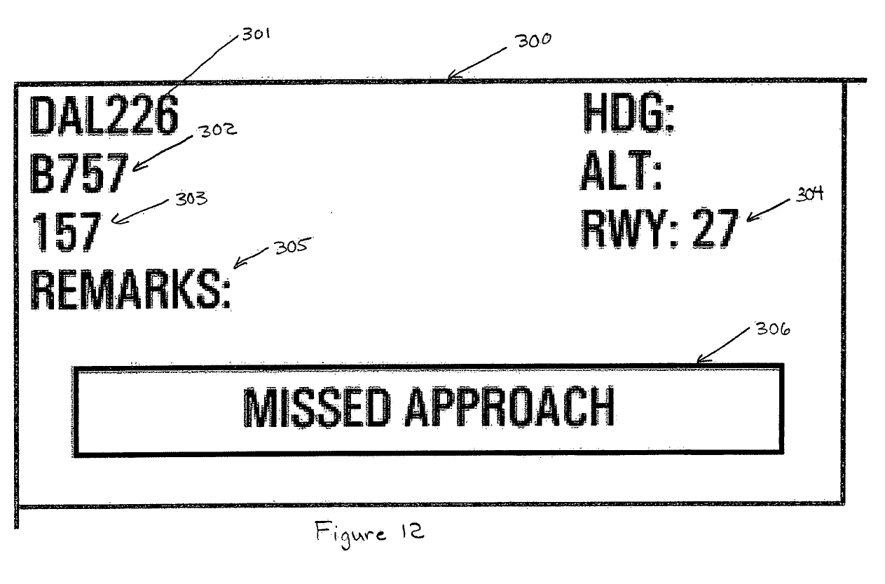

When a controller selects a data block or a FDE from one of the lists, the full set of flight data attributes appears in the readout area. Different attributes appear depending on whether the associated aircraft is an arriving or departing flight. As shown in FIG. 12, when the controller selects an arriving aircraft's FDE, the aircraft's call sign 301, type 302, computer identification (CID) 303, runway assignment 304, and remarks 305 appear in the readout area. For arriving aircraft, the readout area also contains a missed approach button 306. When the controller selects the missed approach button, the flight data system automatically assigns a standard altitude and heading in the aircraft's flight data information based on the aircraft's runway assignment.

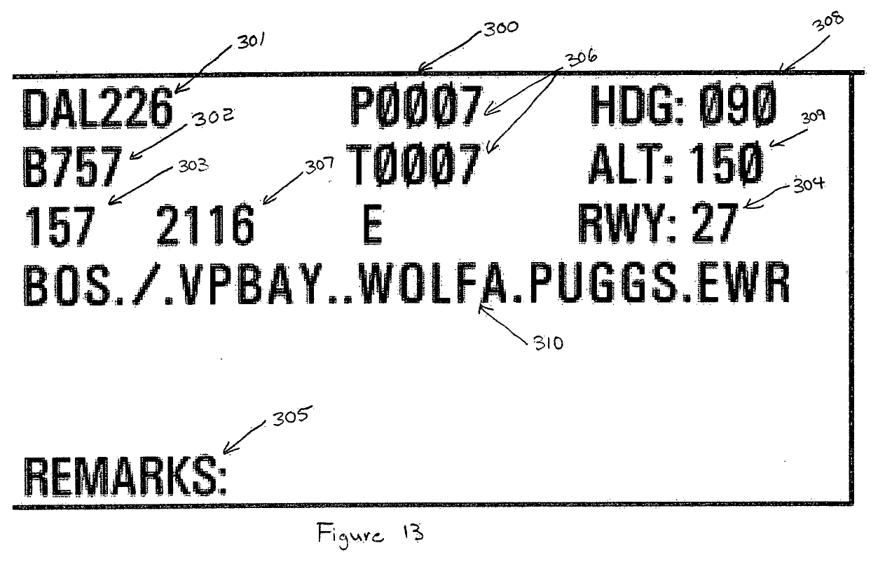

As shown in FIG. 13, the readout area 300 for departing aircraft works in the same general way as the readout area for arriving aircraft. The primary difference is that departing aircraft have more flight data attributes than arriving aircraft. When the controller selects a departing aircraft's FDE or data block, the readout area 300 displays the aircraft's call sign 301, type 302, CID 303, beacon code 307, proposed departure time, taxi time, or EDCT 306, assigned heading 308, assigned altitude 309, assigned runway and intersection departure 304, full route of flight 310, and remarks 305.

The readout area can also show a history of recent FDEs that a controller transferred to another position or facility. For example, the ground controller can display in the readout area the last four FDEs transferred to the local controller by selecting the local controller button. When the ground controller selects the local controller button, the FDEs appear muted in the readout area. The ground controller may recall any of the FDEs displayed in the readout area by selecting the FDE and then selecting a list header to place the FDE in the top of that list. Likewise, the local controller can recall an FDE from either the ground controller or the TRACON controller in the same manner. The local controller can select either the ground or TRACON header to see a list of the most recently transferred FDEs in the readout area. The local controller then selects an FDE and the appropriate list header to place the FDE at the top of that list.

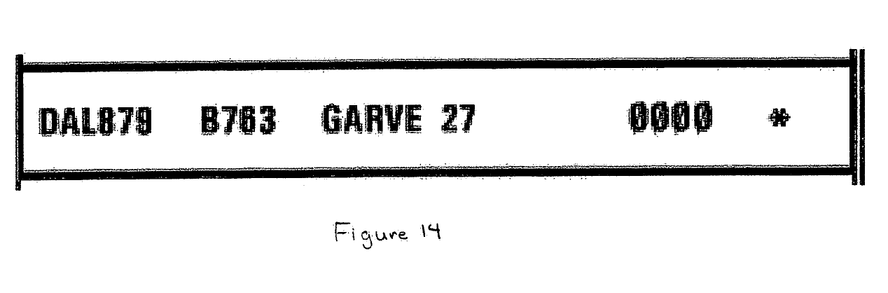

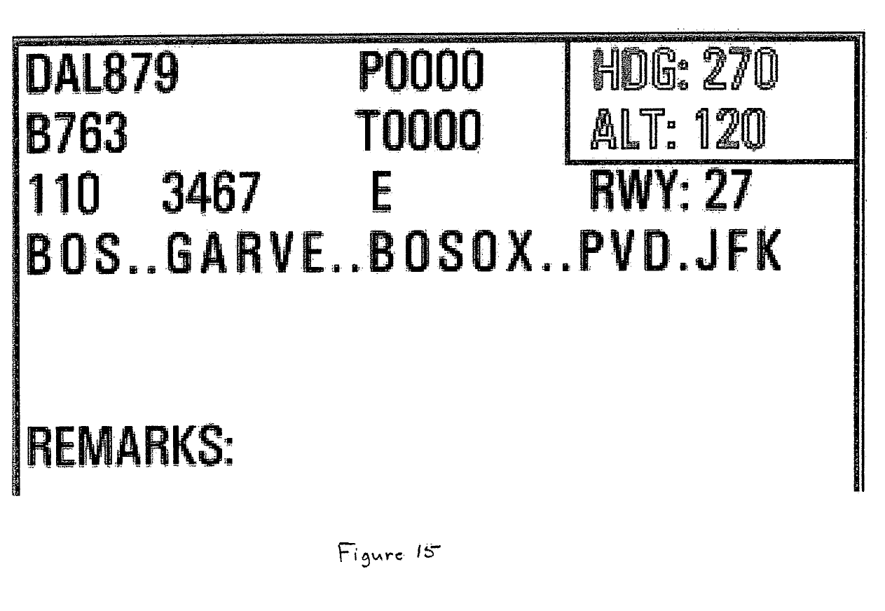

When the controller selects a FDE or data block, they may change the altitude or heading assignment by typing “a” for altitude or “h” for heading followed by a three-digit number and the “Enter” key. The controller can change both the altitude and the heading assignments at the same time by linking the commands. For example, when the controller selects an FDE or data block and the flight data appears in the readout area, the controller can type “a120h350” and press the “Enter” key to change the altitude to 12,000 feet and the heading to 350 degrees. The controller can link the commands in the opposite order to obtain the same result. The controller may include spaces, but entries that violate the syntax rule or exceed the range of possible values return an “Invalid Entry” message to the preview area on the surface situation display. When a controller changes an altitude or heading assignment, an asterisk will appear on the right hand side of the aircraft's FDE as shown in FIG. 14 and appears highlighted in the readout area as shown in FIG. 15. When a controller transfers the FDE to another controller, the asterisk notifies the receiving controller that there has been a change to either the altitude or the heading assignments. The controller can select the FDE displaying the asterisk and examine the flight data in the readout area. The changed flight data attributes appear highlighted until the controller acknowledges the change by touching the readout area. Acknowledging the change turns off the highlighting in the readout area and removes the asterisk from the FDE.

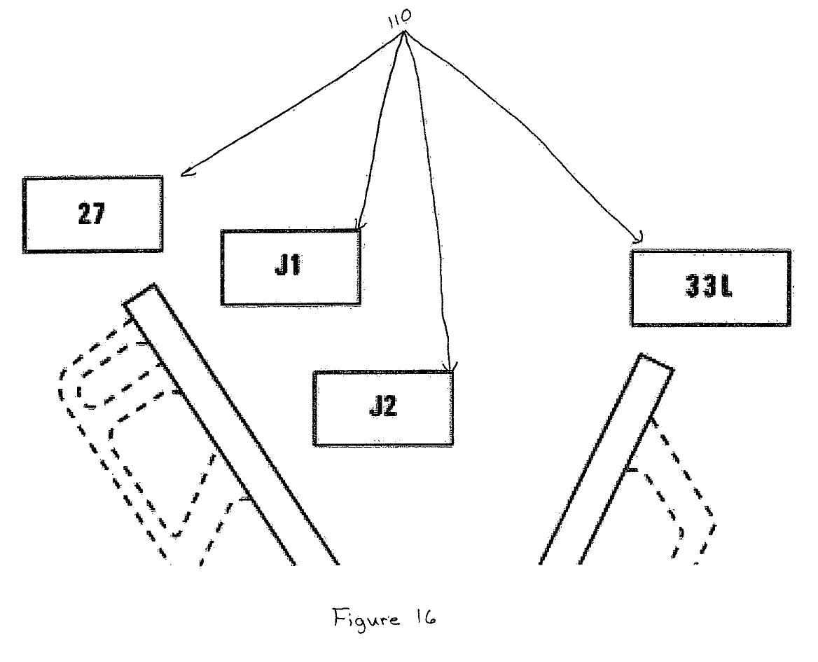

Each list header 201 as shown in FIG. 4 functions as a button that the controller can select. Buttons, similar to FDEs and data blocks, provide visual feedback to the controller when activated. Both the ground and local controller can change an aircraft's runway assignment or assign an intersection departure by selecting the aircraft's FDE or data block and then selecting the appropriate button located on the surface situation display. The flight data system prevents the controller from assigning invalid combinations of runway and intersection assignments. Controllers can place the runway and intersection assignment buttons anywhere on the situation display. FIGS. 2, 3, and 16 show buttons 110 on the surface situation display 100 that the controller can use to assign and record runway and intersection departure assignments. Assigning a new runway or an intersection departure will update the information in the aircraft's FDE, data block, and the readout area.

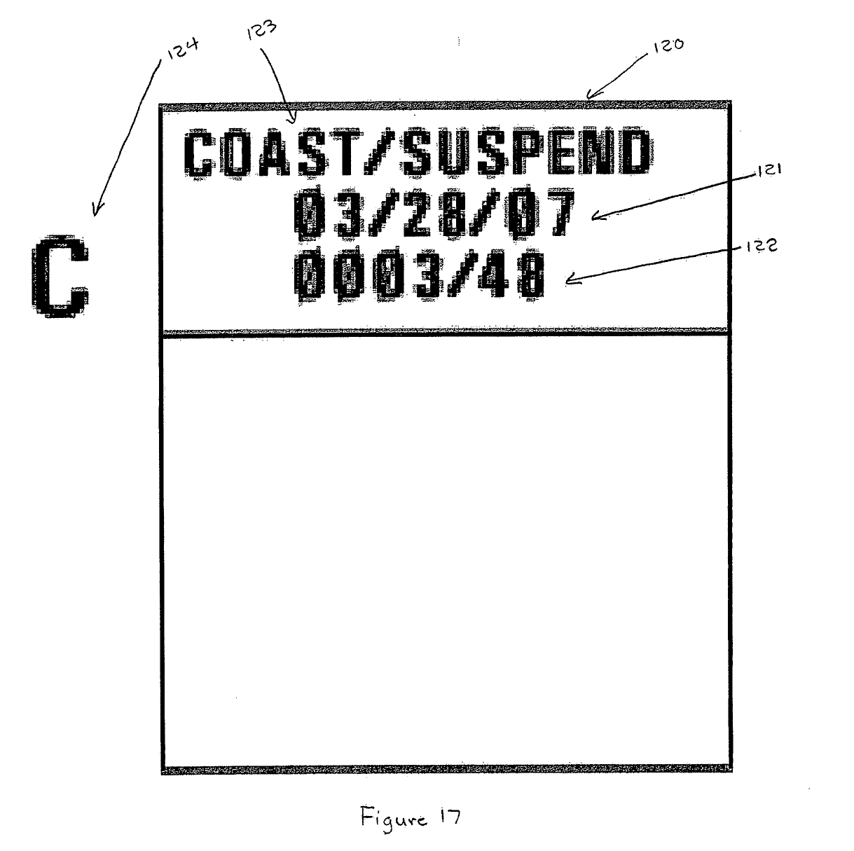

As shown in FIGS. 2, 3, and 17, the system information window 120 is transparent and is located on the surface situation display 100. The system information window 120 contains the current date 121, time displayed in hours, minutes, and seconds UTC 122, coast/suspend track list 123, and current ATIS code 124. The controller uses the ASDE-X display functions to locate this window anywhere within the situation display. The controller cannot place the system information window over the EFD lists or the readout area.

The ATIS is a continuous broadcast of recorded or automated non-control information. The ATIS usually updates about once an hour, but may update more often when special circumstances arise or when weather conditions change rapidly. Controllers must use a procedure on initial contact with an aircraft to verify that the pilot has most recent ATIS information. If the pilot does not have the most recent information, the controller will provide it or request the pilot get it before receiving any further air traffic control clearances.

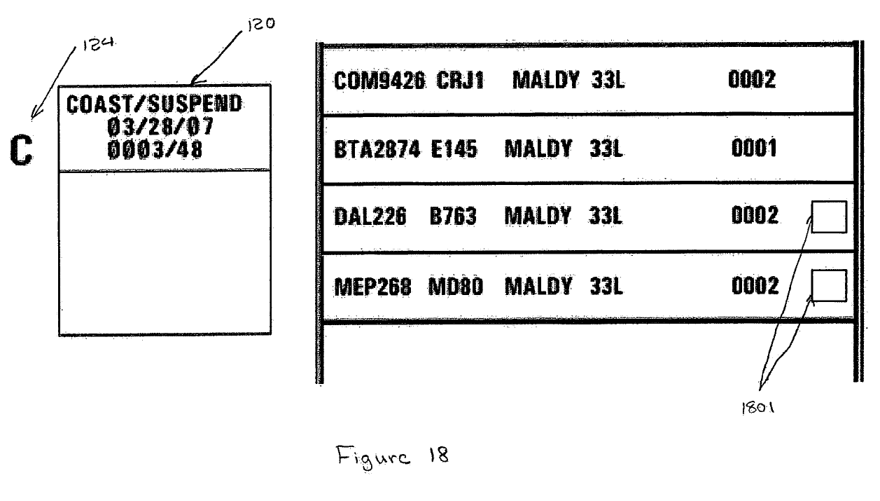

The current ATIS code 124 as shown in FIG. 18 works by alerting the controller whenever the ATIS changes. An ATIS change automatically causes the ATIS code 124 to flash near the system information window 120. In the preferred embodiment, the ATIS code appears yellow for 1.5 seconds and then white for 1.5 seconds for a total duration of 15 seconds. The controller can acknowledge the ATIS change by touching the flashing ATIS code 124, at which time the ATIS code stops flashing and displays normally, in the preferred embodiment, gray. If the controller does not acknowledge the ATIS change after 15 seconds, the ATIS code stops flashing and is displayed in yellow. The ATIS code remains displayed in yellow until the controller acknowledges the ATIS change by touching the ATIS code 124 near the system information window 120.

In addition to alerting the controller to ATIS updates, the Integrated EFDI also indicates which aircraft to advise of the change. As shown in FIG. 18, on the ground controller's EFDI, some of the FDEs appear in the pending list with a box indicator 1801 on the right hand side. This indicator reminds the controller to ensure that the pilot of the aircraft has the current ATIS information. Once the controller provides the current ATIS information to the pilot, the controller touches the box indicator in the arrival aircraft's FDE to make it disappear. The ATIS update indicator will reappear when a new ATIS code is generated.

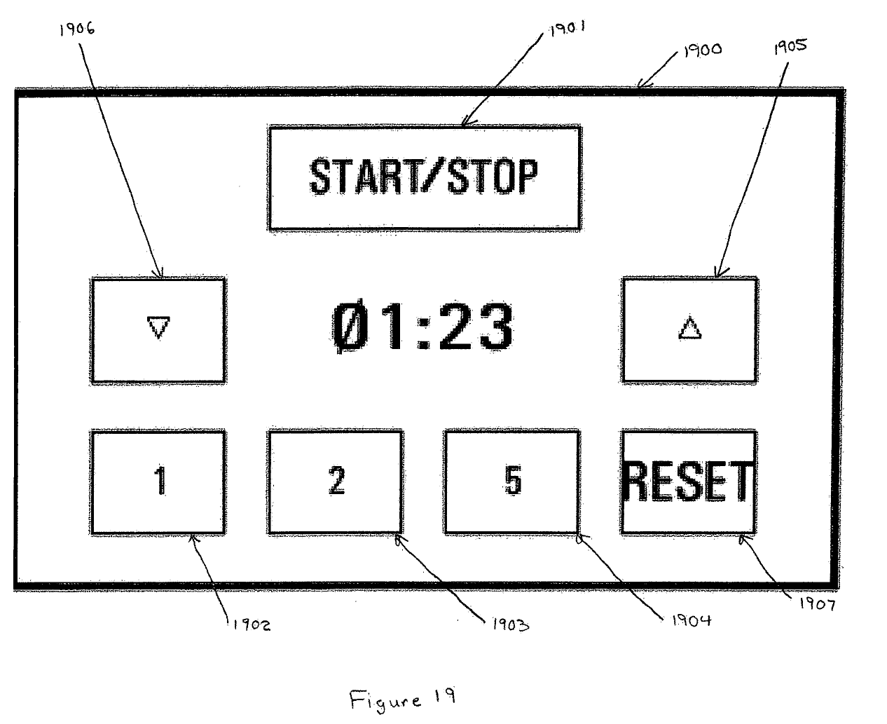

Controllers must use timing to merge traffic streams and to ensure proper separation between aircraft during takeoff and landing. For example, when trying to ensure separation for wake turbulence on departure, controllers must track the time between takeoffs from the same runway. On the Integrated EFDI, the timer works automatically with departing aircraft to assist the controller to determine the appropriate departure spacing. Once an aircraft begins its takeoff roll as sensed by the ASDE-X or other surface surveillance system, the time field 705 in the aircraft's FDE 210 is automatically replaced by a timer that begins to increment from zero as shown FIG. 7. Once the timer reaches the appropriate time, the controller can release the next aircraft for departure. This timer will improve controller efficiency because it removes the controller's need to remember or record the departure time. This timer also reduces the cognitive workload associated with keeping track of how much time has elapsed since the previous departure. To use the timer generically, the controller selects the current time/data field in the system information window to activate the timer interface 1900 as shown in FIG. 19.

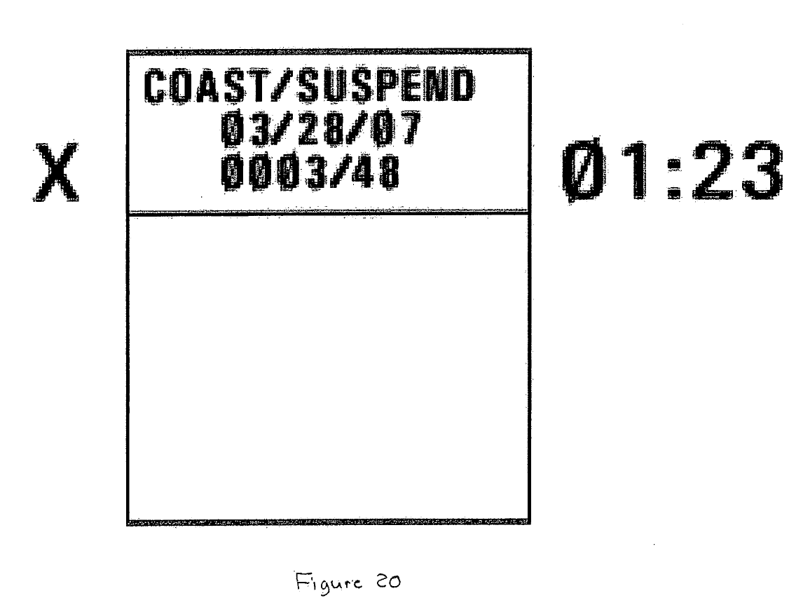

The controller can drag the timer interface to a preferred location on the Integrated EFDI by using either the upper-left or upper-right corner as a handle. To set the generic timer, the controller selects the amount of time desired and then selects the start/stop button 1901 to begin a countdown. The controller can select one of the numbered buttons to add one 1902, two 1903, or five 1904 minutes to the timer, or the controller can select the up arrow 1905 to add one minute or the down arrow 1906 to subtract one minute. Selecting the reset button 1907 will reset the timer to zero. In the preferred embodiment, when the controller selects a button on the timer interface, the button provides visual feedback by appearing with a white background when activated. Once the controller starts a generic timer by selecting the start/stop button 1901, the timer appears to the right of the system information window as shown in FIG. 20. In the preferred embodiment, when the timer is running, the border around the start/stop button 1901 is green and the timer counts down. Selecting the start/stop button 1901 button while the timer is running causes the timer to pause and the border around the start/stop button turns red. The timer interface remains visible until the controller selects the current date/time field in the system information window. The controller can make the timer interface visible again by selecting the timer located to the right of the system information window as shown in FIG. 20. Once the time on the timer expires, the Integrated EFDI notifies the controller by flashing the expired timer. In the preferred embodiment, the expired timer will flash yellow for 1.5 seconds and then white for 1.5 seconds for a total duration of 15 seconds. After 15 seconds have elapsed, the expired timer appears in yellow text. The controller can acknowledge the elapsed timer while it is flashing or after it stops flashing. Acknowledging the elapsed timer by selecting it causes the timer to disappear from the display.

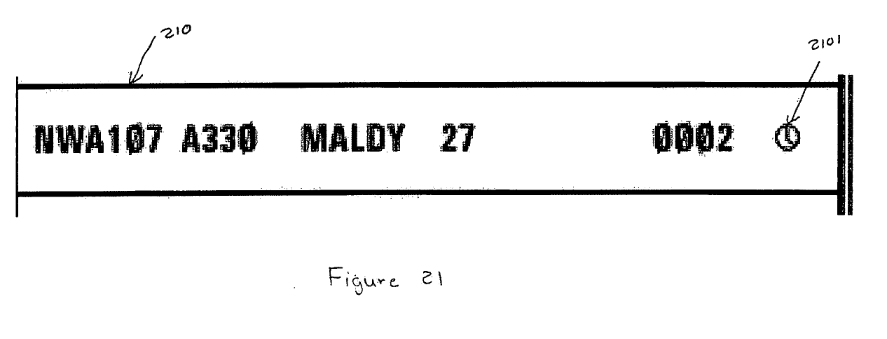

The controller can associate a timer with a particular aircraft by selecting the aircraft's FDE or data block and then activating the timer interface. The timer interface appears and operates as when using the timer generically. As shown in FIG. 21, when the controller associates a timer with a particular aircraft, a timer icon 2101 appears in the aircraft's FDE 210. When the timer expires, the Integrated EFDI notifies the controller by flashing the timer icon 2101 on the associated aircraft's FDE 210. The controller can acknowledge the elapsed timer by selecting the timer icon 2101 causing it to disappear. A generic or aircraft associated timer set by a controller on that particular controller's Integrated EFDI position will not appear at any other controller's Integrated EFDI position. However, if the controller has associated a timer with an aircraft and then transfers the FDE for that aircraft, the aircraft specific timer will accompany the FDE.

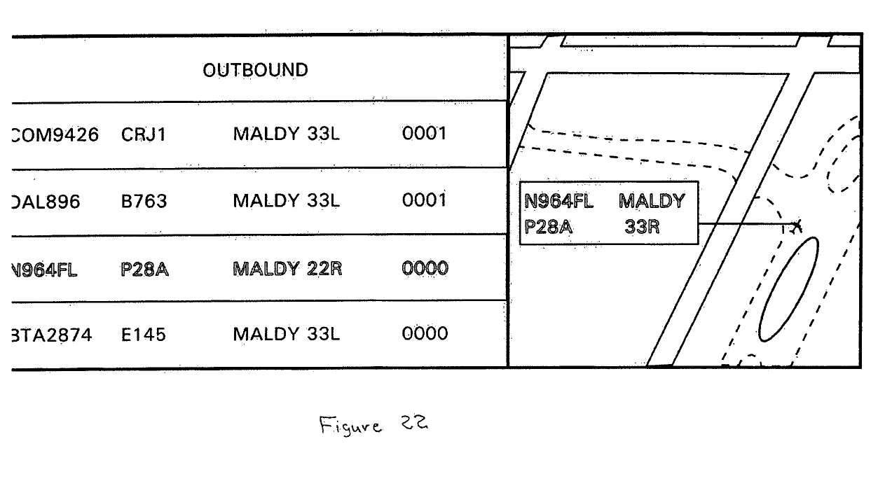

Air traffic controllers use a number of techniques to make certain pieces of flight data information more conspicuous. Highlighting information is a relatively easy way to create conspicuity. Controllers may highlight particular pieces of information that are unusual or especially critical to operations. Controllers can highlight flight data on the Integrated EFDI by selecting a FDE or data block and then selecting the readout area. In the preferred embodiment as shown in FIG. 22, highlighting flight data causes the text for the selected FDE and data block to appear in light blue. To remove the highlighting, the controller selects the highlighted FDE or data block and then selects the readout area.

The Integrated EFDI uses automatic highlighting to indicate situations that need special attention. Automatic highlighting occurs when an aircraft has taxied into position and is holding on the runway, when there is expired time information such as a departure delay, or when an aircraft has an EDCT.

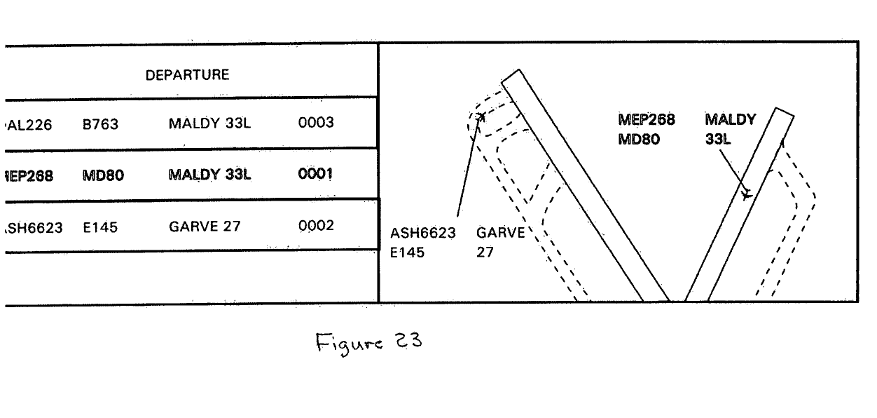

Aircraft waiting on an active runway present a potential problem that is inherent in the procedure known as “Taxi into Position and Hold (TIPH).” Controllers use the TIPH procedure to maximize the efficiency of runway usage. The TIPH procedure allows controllers to clear an aircraft for takeoff, and then place another aircraft on the runway in position and ready to take off as soon as possible. However, controllers must remember when an aircraft is holding on the runway to prevent possible runway incursions and collisions. The Integrated EFDI uses the surface surveillance system to automatically detect and indicate when an aircraft is holding or stopped on an active runway by highlighting the aircraft's FDE and data block as shown in FIG. 23. Once the aircraft begins its takeoff roll, the Integrated EFDI automatically removes the highlighting.

As soon as the Integrated EFDI records a taxi time for an aircraft, the Integrated EFDI automatically starts a count down on a departure delay timer for the associated aircraft. The departure delay timer provides an indication for aircraft that are “delayed” on the airport surface. An airport surface delay occurs when an aircraft remains on the airport surface for 15 minutes or longer after entering FAA jurisdiction. In the preferred embodiment, if 20 minutes of time elapse before the local controller clears an aircraft for departure, the time field on the FDE associated with that aircraft will appear highlighted with a yellow background and black text to indicate that the aircraft has entered a delay status. The Integrated EFDI automatically records the number and duration of each departure delay for subsequent reporting. The user may adjust the amount of time that must elapse before a delay is incurred.

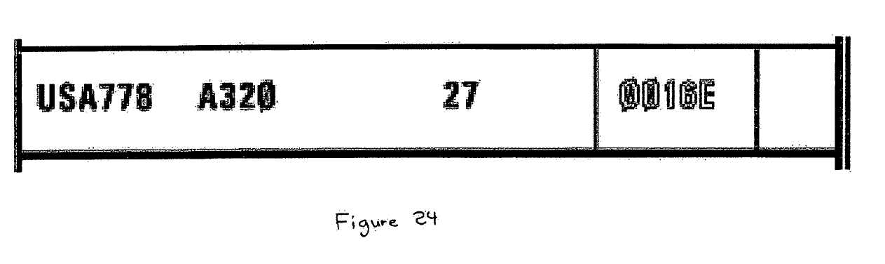

The Integrated EFDI also has an automatic reminder for aircraft that have an Expected Departure Clearance Time (EDCT). This is necessary because of the undesirable consequences that may occur if an EDCT expires. An aircraft must depart at or near the EDCT to maintain its position in the scheduled traffic flow or else incur a delay. If an aircraft does not depart within 30 minutes after an assigned EDCT, the National Airspace System (NAS) automatically deletes the aircraft's filed flight plan from the system. In the preferred embodiment, if an aircraft has an EDCT, that field appears highlighted in the FDE and the letter “E” is appended to the time as shown in FIG. 24. The Integrated EFDI automatically alerts the controller when an aircraft has not departed within ten minutes before an assigned EDCT by flashing the time field on the aircraft's FDE. The flashing EDCT operates in the same manner as the ATIS update indicator and the timers. If the controller does not acknowledge the flashing EDCT during the 15 second flashing period, the flashing stops and the EDCT displays highlighted with a yellow background and black text. This reminds the controller to take action to clear the aircraft for departure in the near future. A second EDCT warning occurs at the EDCT. If an aircraft has not departed by its assigned EDCT, the Integrated EFDI alerts the controller by flashing the EDCT again. The second reminder flashes the EDCT between white and orange for 15 seconds. If the controller does not acknowledge the second EDCT reminder within the 15 second period, then the EDCT appears highlighted with an orange background and black text.

What is claimed is:

1. In an air traffic control system including a processor, memory, source of electronic flight data, a ground surveillance system to report aircraft and vehicle position on and near the airport surface, a touch sensitive display device, keyboard, trackball/keypad, a method of displaying electronic flight data together with airport surface position data comprising the steps of:
displaying flight data information as color coded flight data elements in electronic flight data lists, said electronic flight data lists may be located by the user on either side of said touch sensitive display device;
displaying said flight data information in data blocks that are associated with a surface situation display on said touch sensitive display device indicating aircraft and vehicle locations from surface surveillance system data;
moving said data blocks by touching and dragging said data blocks to a desired location within said surface situation display;
displaying only necessary said color coded flight data elements for a particular operation;
displaying full flight data information for an aircraft in a readout area on said surface situation display, said full flight data information appearing when user touches said flight data elements or said data blocks;
using a set of touch activated buttons displayed on said surface situation display to change an aircraft's runway, intersection assignment, or other flight data attributes;
using a system information window on said surface situation display to display the current date, time, and Automatic Terminal Information Service (ATIS) code; and
using a set of reminders that include an ATIS update status indication, generic and aircraft associated timers, highlighted critical information, a taxi into position and hold indication, an aircraft associated runway spacing timer, and an expected departure clearance time reminder.

2. The method of claim 1, wherein the step of displaying flight information as flight data elements in electronic flight data list further comprises the steps of:
displaying a pending list at a ground controller's position wherein said pending list contains flight data attributes comprising of a call sign, aircraft type, runway assignment, proposed departure time or estimated departure clearance time, and an ATIS update indication for aircraft waiting in a ramp area to contact said ground controller to get a taxi clearance;
displaying an outbound list at said ground controller's position wherein said outbound list contains flight data attributes comprising of a call sign, aircraft type, destination/first departure fix, runway assignment, taxi time, and an ATIS update indication for aircraft that said ground controller has given a taxi clearance;
displaying a departure list at a local controller's position wherein said departure list contains flight data attributes comprising of a call sign, aircraft type, first departure fix, runway assignment, taxi clearance time or estimated departure clearance time or time since departure, and an ATIS update indication for aircraft waiting to contact said local controller for a clearance for takeoff;
displaying an arrival list at said local controller's position wherein, said arrival list contains flight data attributes comprising of a call sign, aircraft type, runway assignment, and an ATIS update indication for aircraft that are on approach to an airport;
displaying an inbound list at said ground controller's position wherein said inbound list contains flight data attributes comprising of a call sign and aircraft type for arriving aircraft waiting for a taxi clearance back to said ramp area from said ground controller;
moving flight data elements within said lists by touching and dragging said flight data elements and then releasing in a desired location; and
moving flight data elements between said lists by touching said flight data elements and then touching an active area in a desired location.
